(19) United States
(12) Patent Application Publication
(10) Pub. No.: US 2014/0193092 A1
(43) Pub. Date: Jul. 10, 2014

(54) SUPERRESOLUTION IMAGE PROCESSING USING AN INVERTIBLE SPARSE MATRIX

(71) Applicant: LSI Corporation, San Jose, CA (US)

(72) Inventors: Alexander Alexandrovich Petyushko, Bryansk (RU); Dmitry Nikolaevich Babin, Moscow (RU); Ivan Leonidovich Mazurenko, Khimki (RU); Alexander Borisovich Kholodenko, Moscow (RU)

(73) Assignee: LSI CORPORATION, San Jose, CA (US)

(21) Appl. No.: 13/950,384

(22) Filed: Jul. 25, 2013

(30) Foreign Application Priority Data
Jan. 9, 2013 (RU) 2013100160

(51) Int. Cl. G06K 9/46

(52) U.S. Cl. CPC G06K 9/4638
USPC 382/260

(57) ABSTRACT

Superresolution image processing that can be applied when two image frames of the same scene are available so that image information from one frame can be used to enhance the image from the other frame. The superresolution image processing uses a sparse matrix generated based on a Markov random field defined over these two image frames. The sparse matrix is inverted and applied to the image data from the image frame that is being enhanced to generate a corresponding enhanced image.

### FIELD

The present disclosure relates to image processing and, more specifically but not exclusively, to superresolution image processing.

### BACKGROUND

As used herein the term “superresolution” (SR) refers to a class of signal-processing techniques designed to enhance the effective spatial resolution of an image or an imaging system to better than that corresponding to the size of the pixel of the original image or image sensor. SR-image enhancement is proving to be useful, for example, in medical-imaging systems, satellite-imaging systems, motion-sensing input devices, computer graphics and animation, three-dimensional scanners, etc. However, SR image-processing techniques are not yet sufficiently developed to satisfy the diverse requirements of all prospective applications.

### SUMMARY

Various embodiments disclosed herein rely on superresolution image processing that can be applied when two image frames of the same scene are available so that image information from one frame can be used to enhance the image from the other frame. The superresolution image processing uses a sparse matrix generated based on a Markov random field defined over these two image frames. The sparse matrix is inverted and applied to the image data from the image frame that is being enhanced to generate a corresponding enhanced image.

Some embodiments include a non-transitory machine-readable medium, having encoded thereon program code, wherein, when the program code is executed by a machine, the machine performs the above-mentioned superresolution image processing.

Some other embodiments include an imaging system configured to perform the above-mentioned superresolution image processing.

### BRIEF DESCRIPTION OF THE FIGURES

Other embodiments of the disclosure will become more fully apparent from the following detailed description and the accompanying drawings, in which:

FIG. 1 shows a block diagram of an imaging system according to an embodiment of the disclosure;

FIG. 2 graphically shows an exemplary two-layer lattice on which a Markov random field (MRF) can be defined for superresolution image processing in the imaging system of FIG. 1 according to an embodiment of the disclosure;

FIG. 3 shows a flowchart of a processor-implemented MRF-based method of generating an upsampled image frame that can be used in the imaging system of FIG. 1 according to an embodiment of the disclosure; and

FIG. 4 shows a general structure of a sparse matrix generated by and used in the method shown in FIG. 3 according to an embodiment of the disclosure.

### DETAILED DESCRIPTION

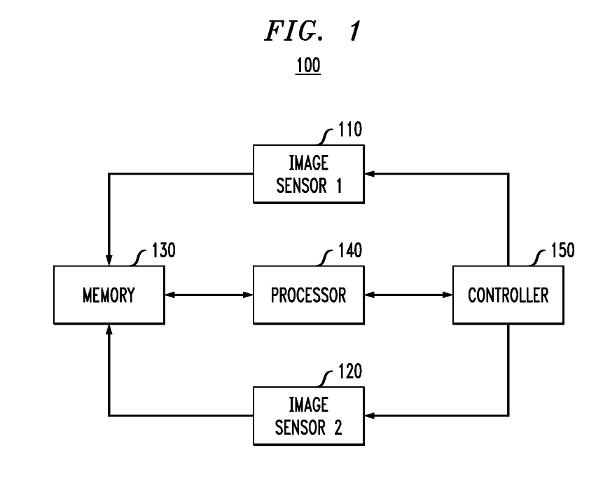

FIG. 1 shows a block diagram of an imaging system 100 according to an embodiment of the disclosure. System 100 has image sensors 110 and 120 coupled to a memory 130, a signal processor (e.g., a DSP) 140, and a controller 150 as indicated in FIG. 1. Controller 150 generally controls the operation of image sensors 110 and 120 and can configure the image sensors to capture respective image frames of the same scene. Image sensors 110 and 120 are configured to transfer the captured image frames to memory 130 for storage and/or further processing in processor 140. In some embodiments, at least some portions of system 100 can be implemented as a system on a chip (SOC).

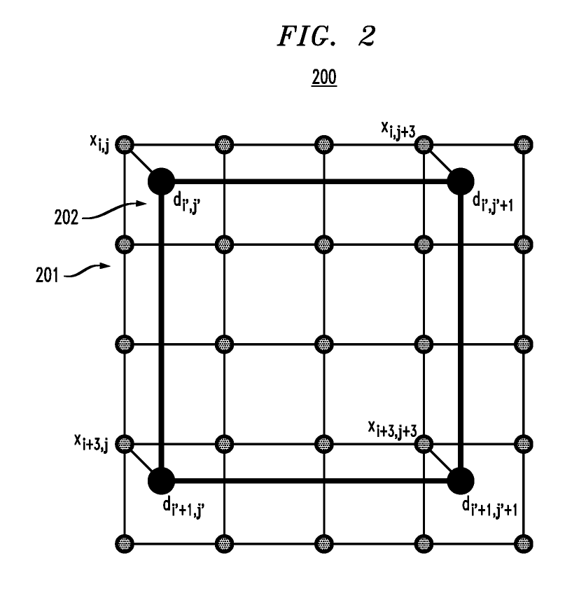

In general, processor 140 can be configured to perform various types of conventional image processing on an individual image frame retrieved from memory 130 and, optionally, using the corresponding sensor-configuration information received from controller 150. However, of particular interest to this disclosure is a type of image processing in which processor 140 uses image data from an image frame of a scene captured by image sensor 120 to enhance the image of the same scene captured by image sensor 110, or vice versa. This type of image processing is described in more detail below in reference to FIGS. 2-4.

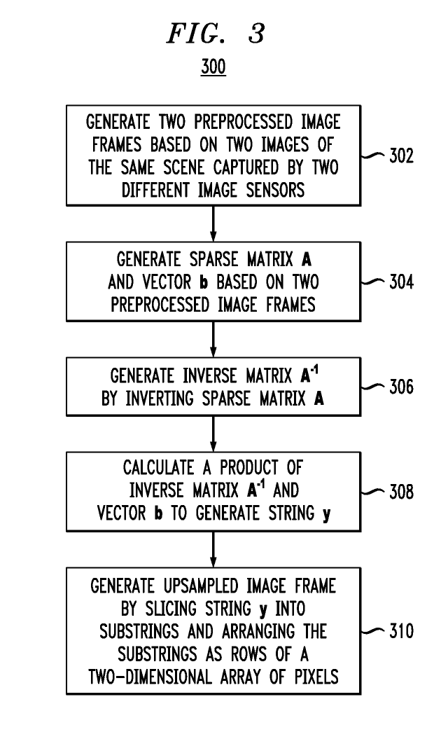

In general, images of the same scene captured by sensors 110 and 120 are not precisely aligned with one another, e.g., due to differences in the positions/orientations of the image sensors in system 100, different respective fields of view, etc. As a result, processor 140 may be configured to perform some image-frame preprocessing, e.g., prior to the application of the pertinent superresolution (SR) image-processing technique, such as method 300 (FIG. 3). One possible embodiment of such preprocessing includes the steps of (i) image registration and (ii) image trimming.

Image registration is a process of identifying respective portions of two image frames corresponding to the same (common) field of view of the captured scene. In various embodiments, image registration can be performed: (i) manually, with the user providing appropriate input on how the two image frames are geometrically related to one another; (ii) automatically, with system 100 itself determining the geometric relationship between the two image frames, e.g., using an affine transform and least-mean-square (LMS) error minimization; or (iii) semi-automatically, where some combination of user-driven and automatic image-overlap determination is used.

Image trimming is a process of removing the respective non-overlapping parts of the two image frames. After image registration has been performed, image trimming is relatively straightforward to implement and can be done, e.g., by appropriately changing the image boundary and discarding the image data corresponding to the image portions located outside the new image boundary.

In one embodiment, the rules of image registration and trimming can be established once during calibration of system 100 and then applied thereafter, without change, to each pair of image frames captured by sensors 110 and 120. The subsequent description of various embodiments of superresolution image processing implemented in processor 140 assumes that the two corresponding image frames have been appropriately preprocessed and, as such, are properly registered with respect to one another and trimmed.

In various specific embodiments, system 100 can have the following pairs of image sensors 110 and 120: (i) a range sensor 110 and a luminance sensor 120; (ii) an infrared sensor 110 and a visible-light sensor 120; (iii) a low-resolution, high-speed photo camera 110 and a high-resolution, low-speed photo camera 120; and (iv) a first range sensor 110 and a second range sensor 120, with the two range sensors being enabled by two respective different range-sensing technologies. In alternative embodiments, other sensor combinations can also be used.

As used herein, the term “range sensor” refers to a device configured to capture a depth map of a scene from the viewpoint of the device, usually by measuring distances to the nearest surfaces within the field of view. Various technologies are currently available for implementing a range sensor, with several representative range-sensing technologies being: (i) single-point laser scanning, (ii) slit scanning, (iii) encoded-pattern projection and capture, and (iv) time-of-flight scanning. More details on these and other range-sensing technologies can be found, e.g., in the article by Blais, F., “Review of 20 Years Range Sensor Development,” Journal of Electronic Imaging, 2004, v. 13, pp. 231-240, which article is incorporated herein by reference in its entirety.

For clarity and without limitation, the subsequent description is given in reference to an embodiment of system 100 in which sensor 110 is a range sensor having a relatively low spatial resolution, and sensor 120 is a conventional luminance sensor having a relatively high spatial resolution. From the provided description, one of ordinary skill in the art will be able to make and use, without undue experimentation, alternative embodiments corresponding to different alternative combinations of sensors 110 and 120.

In one embodiment, processor 140 is configured to implement superresolution image processing that treats image frames using a Markov-random-field (MRF) method. The concept of MRF, as it pertains to the present disclosure, is briefly explained below. A detailed treatise on Markov random fields can be found, e.g., in the book by Ross Kindermann and J. Laurie Snell, entitled “Markov Random Fields and Their Applications,” published in 1980 by the American Mathematical Society, which book is incorporated herein by reference in its entirety.

Let us assume that the preprocessed frames captured by sensors 110 and 120 are rectangular in shape and have the sizes of M₁×N₁ pixels and M₂×N₂ pixels, respectively, where M₁<M₂, N₁<N₂, and M₁/N₁=M₂/N₂. The first two conditions are mathematical expressions of the fact that sensor 110 has a lower spatial resolution than sensor 120. The last condition is a mathematical expression of the fact that the two frames have the same aspect ratio. The preprocessed image frames captured by sensors 110 and 120 are hereafter denoted as frame D and frame X, respectively, wherein:

D={d_{i′j′}}, where 1≦i′≦M₁, 1≦j′≦Nₗ, and 0≦d_{i′j′}≦1; and

X={x_{i,j}}, where 1≦i≦M₂, 1≦j≦N₂, and 0≦x_{i,j}≦1,

where d and x denote the values corresponding to individual pixels in frames D and X, respectively; and the indices i, j, i′, and j′ point to locations of the individual pixels in the image frames. Note that, in general, the values of d and x do not necessarily need to be between 0 and 1, and the above-specified unity ranges are specified for convenience of mathematical treatment. One of ordinary skill in the art will understand that a relatively straightforward linear transform can be used to appropriately adjust the values of d and x to make them fall into the respective unity ranges.

FIG. 2 graphically shows an exemplary two-layer pixel lattice 200 on which a Markov random field can be defined for superresolution image processing in system 100 according to an embodiment of the disclosure. A first layer 201 of lattice 200 comprises the pixels of image frame X. A second layer 202 of lattice 200 comprises the pixels of image frame D. For illustration purposes, FIG. 2 shows an example corresponding to a three-fold resolution difference between frames X and D. In mathematical terms, the resolution difference can be quantified, e.g., using the parameter m≡(M₂−1)/(M₁−1). In the example shown in FIG. 2, m=3. Other positive integer values of parameter m can similarly be used. Moreover, one of ordinary skill in the art will appreciate that parameter m can be effectively forced to an integer value for any frame sizes because an appropriate number of black (zero-valued) stripes of pixels can be added to appropriately pad frame D and/or frame X for the parameter m to be an integer.

Layers 201 and 202 in lattice 200 are coupled to one another by the edges that connect the pixels of frames X and D, for which the following conditions are satisfied:

(i−1)mod m=0 (1a)

(j−1)mod m=0 (1b)

i′−1=(i−1)/m (1c)

j′−1=(j−1)/m (1d)

A Markov random field (R) is defined in terms of probability (P) and represents a particular type of a discrete random field in which the probability of finding a particular pixel value at pixel location (i,j) in random field R depends only on the pixel values of the direct neighbors of the pixel, i.e., pixels (i−1,j), (i+1,j), (i,j−1), and (i,j+1), which are sometimes referred to as “up,” “down,” “left,” and “right” neighbors, respectively. Note that, when the pixel is located at the boundary of the image frame, the pixel can have fewer than four direct neighbors. For example, corner pixels have only two direct neighbors, and frame-edge pixels have only three direct neighbors.

Eq. (2) gives the conditional probability distribution over random field R defined on lattice 200:

P(R|X, D)=Z⁻¹ exp[−(V+U)/2] (2)

where Z is a normalizer (partition function); V is a first potential defined on lattice 200; and U is a second potential defined on lattice 200. The spatial resolution of random field R matches the spatial resolution of image frame X. In other words, random field R has the same effective number of pixels as frame X, and therefore can be written as:

R={r_{i,j}}, where 1≦i≦M₂, 1≦j≦N₂, and 0≦r_{i,j}≦1,

where r denotes the values of R corresponding to individual pixels of layer 201, wherein, in each pair of connected pixels from layers 201 and 202, random field R has the same value.

The first potential is defined on layer 201 as follows:

$$V = {\sum }_{i , j}^{ } {\sum }_{( k , l ) ∈ N ( i , j )}^{ } {{w}_{( i , j ) ( k , l )} ( {r}_{i , j} - {r}_{k , l} )}^{2} \qquad ( 3 a )$$

where N(i,j) is a set of direct neighbors of pixel (i,j) in layer 201; and w_{(i,j)(k,l)} is a set of weighting coefficients defined by Eq. (3b):

w_{(i,j)(k,l)}=exp[−c(x_{i,j}−x_{k,l})²] (3b)

where c is a smoothing constant. Note that the first potential, as defined by Eqs. (3a)-(3b), quantifies the spatial smoothness of random field R using the spatial smoothness of image frame X as a measure.

The second potential is defined on lattice 200 as follows:

$$U = q \times {\sum }_{( i , j ) ( {i}^{′} , {j}^{′} ) a Eqs . ( 1 a ) - ( 1 d )}^{ } {( {r}_{i , j} - {d}_{{i}^{′} , {j}^{′}} )}^{2} \qquad ( 4 )$$

where q is a weighting constant corresponding to image frame D; and the sum is taken over the pixels of lattice 200 that are coupled to one another by the respective edges connecting layers 201 and 202. Note that the second potential, as defined by Eq. (4), measures the quadratic distance between random field R and image frame D.

The superresolution image processing implemented in processor 140 is generally directed at generating an upsampled image frame R={r_{i,j}}, for which the conditional probability distribution P(R|X, D) expressed by Eq. (2) has a maximum value or is sufficiently close to said maximum value. Various embodiments of the computational methods described below enable processor 140 to generate such an upsampled image frame in a computationally efficient manner, without overtaxing the computational resources of system 100, and/or in a relatively short amount of time. In some embodiments, an exact (subject only to the rounding errors) mathematical solution of the above-formulated probability maximization problem can be calculated by processor 140, e.g., as further explained below.

FIG. 3 shows a flowchart of a processor-implemented MRF-based method 300 of generating an upsampled image frame, R={r_{i,j}}, that can be used in system 100 (FIG. 1) according to an embodiment of the disclosure.

At step 302 of method 300, system 100 generates preprocessed image frames D and X, e.g., using image registration and image trimming as explained above. Image frame D contains image data captured by sensor 110. Image frame X contains image data captured by sensor 120. Both image frames represent the same scene.

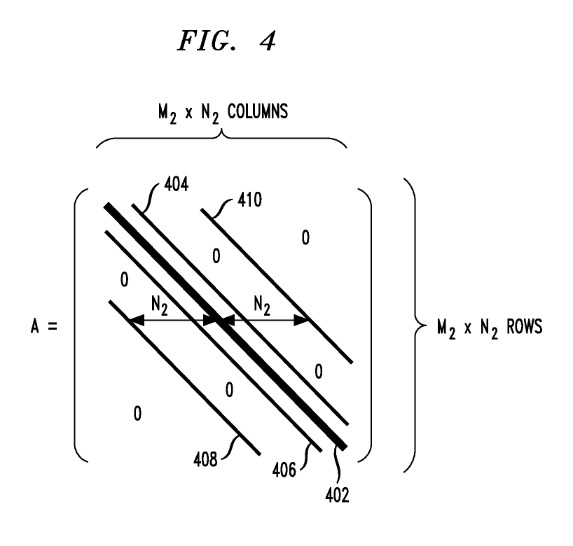

At step 304, system 100 generates a sparse matrix, A, and a vector column, b, based on the data from the image frames D and X generated at step 302. The calculation of the various elements of matrix A and vector b can be performed, e.g., in accordance with Eqs. (9) and (10) as further explained below in reference to FIG. 4.

FIG. 4 shows a general structure of sparse matrix A generated at step 304. Matrix A is a square matrix having (M₂×N₂) rows and (M₂×N₂) columns. Most of the matrix elements in matrix A are zero, and the only non-zero elements in matrix A are located on five diagonals 402-410 indicated in FIG. 4 by the respective straight lines, each oriented at a 45-degree angle. Diagonal 402 is a main diagonal that has its ends at the upper-left and lower-right corner elements of matrix A. Diagonals 404 and 406 are the diagonals that are immediately adjacent to the main diagonal. More specifically, diagonal 404 begins at the second element in the first row and ends at the next-to-last element in the last column. Diagonal 406 begins at the second element in the first column and ends at the next-to-last element in the last row. Diagonals 408 and 410 are the diagonals that are horizontally and vertically offset from the main diagonal by N₂ elements. More specifically, diagonal 408 begins at the (N₂+1)-th element in the first column and ends at the (M₂N₂−N₂)-th element in the last row. Diagonal 410 begins at the (N₂+1)-th element in the first row and ends at the (M₂N₂−N₂)-th element in the last column. For some image frames D and X, some (but not all) of the matrix elements located on diagonals 402-410 may be zero. At most, matrix A has 5M₂N₂ non-zero elements. The various non-zero elements of matrix A can be calculated, e.g., using Eqs. (9a)-(9e).

Matrix A and vector b correspond to a reformulation of the above-formulated probability-maximization problem in terms of a system of linear equations that has the form given by Eq. (5):

Ay^{T}=b (5)

where y^{T} denotes a transposed string y={y_{J}}, where 1≦J≦(M₂×N₂). When matrix A and vector b are known, the task of finding string y reduces to the steps of (i) finding matrix A⁻¹, which is the inverse of matrix A, and (ii) calculating the product of matrix A⁻¹ and vector b in accordance with Eq. (6):

y^{T}=A⁻¹b (6)

String y and upsampled image frame R are related to one another through a bijection according to which string y is a concatenation of M₂ sub-strings, each formed by reading out a respective row of pixels from frame R. More specifically, the first N₂ elements in string y represent a readout from the first row of pixels of frame R, {r_{1,j}}. The second N₂ elements in string y represent a readout from the second row of pixels of frame R, {r_{2,j}}. The third N₂ elements in string y represent a readout from the third row of pixels of frame R, {r_{3,j}}, and so on. Therefore, image frame R can be generated from string y by (i) slicing string y into sub-strings of length N₂ and (ii) stacking up the sub-strings in consecutive order to form a corresponding two-dimensional array of pixel values. In mathematical terms, the bijection between string y and frame R is defined by Eqs. (7a)-(7d):

r_{i,j}⇄y_{J} (7a)

J=(i−1)N₂+j (7b)

j=J−N₂ floor(J/N₂) (7c)

i=1+floor(J/N₂) (7d)

Eq. (5) is derived from Eq. (2) by (i) taking derivatives of the conditional probability distribution P(R|X, D) over each r_{i,j} and (ii) setting each derivative to zero because the desired upsampled image frame, R={r_{i,j}}, ideally corresponds to a global maximum of the probability distribution. This set of derivatives is given by Eq. (8):

$$\begin{matrix}\{ \begin{matrix}\frac{d P}{d {r}_{1 , 1}} = 0 , \\ … \\ \frac{d P}{d {r}_{i , j}} = 0 , \\ … \\ \frac{d P}{d {r}_{{M}_{2} , {N}_{2}}} = 0.\end{matrix} & ( 8 )\end{matrix}$$

Using the expressions given by Eqs. (2)-(4) and the bijection defined by Eqs. (7a)-(7d), Eq. (8) is straightforwardly converted into the expressions for matrix elements of A and vector elements of b given by Eqs. (9)-(10), respectively.

Eqs. (9a)-(9e) give expressions for the five matrix elements located on diagonals 402-410 in the K-th row of matrix A:

A_{K-N}_{₂}_{,K}=−w_{(K)(K-N}_{₂}₎ (9a)

A_{K-1,K}=−w_{(K)(K-1)} (9b)

A_{K,K}=w_{(K)(K-1)}+w_{(K)(K+1)}+w_{(K)(K-N}_{₂})+w_{(K)(K+N}_{₂})+qδ_{K} (9c)

A_{K+1,K}=−w_{(K)(K+1)} (9d)

A_{K+N}_{₂}_{,K}=−w_{(K)(K+N}_{₂}₎ (9e)

where w_{(K)(K′)} is the weighting coefficient w_{(i,j)(k,l)} defined by Eq. (3b), wherein the first subscript value (K) denotes the pair (i,j) determined from Eqs. (7c)-(7d) by setting J=K, and the second subscript value (K′) denotes the pair (k,l) similarly determined using Eqs. (7c)-(7d) by setting J=K′ and replacing i and j in those equations by k and l, respectively. The function δ_{K} in Eq. (9c) can be either 0 or 1. More specifically, function δ_{K} has a value of zero when either (i−1) mod m≠0 or (j−1) mod m≠0. Function δ_{K} has a value of one when both (i−1) mod m=0 and (j−1) mod m=0. One of ordinary skill in the art will understand how to modify Eqs. (9a)-(9e) to obtain matrix elements for the rows of matrix A that are intersected by fewer than all five diagonals 402-410.

The elements of vector b={b_{K}}, where 1≦K≦(M₂×N₂), are given by Eq. (10a):

b_{K}=qδ_{K}d_{i′,j′} (10a)

with the values of i′ and j′ given by Eqs. (10b)-(10c):

i′=1+(i−1)/m (10b)

j′=1+(j−1)/m (10c)

where the pair (i,j) is determined from Eqs. (7c)-(7d) by setting J=K. Note that Eq. (10a) has the same function δ_{K} as Eq. (9c). Further note that the elements of vector b are generated based only on the image data from image frame D because Eq. (10a) does not rely on the image data from image frame X.

Referring again to FIG. 3, at step 306, system 100 generates inverse matrix A⁻¹ for the sparse matrix A generated at step 304. In one embodiment, matrix A can be inverted in a conventional manner using the Gauss-Jordan elimination method. In alternative embodiments, other suitable matrix-inversion methods can similarly be used.

The Gauss-Jordan elimination method needs approximately M₂N₂³ operations to invert sparse matrix A shown in FIG. 4. Therefore, to reduce the processing time taken by method 300 in general and step 306 in particular, it might be advisable to sometimes rotate image frames X and D by 90 degrees prior to the application of method 300 to produce an image orientation for which N₂<M₂. If image frames X and D are rotated in this manner, then the upsampled image frame R generated at the completion of the processing of method 300 can be rotated back to correspond to the original (non-rotated) orientation of image frames X and D.

At step 308, system 100 calculates the product of the inverse matrix A⁻¹ generated at step 306 and vector column b generated at step 304 in accordance with Eq. (6) to generate string y.

Finally, at step 310, upsampled image frame R is generated by (i) slicing the string y generated at step 308 into sub-strings of length N₂ and (ii) sequentially arranging the resulting sub-strings as rows of a two-dimensional array of pixels. The resulting two-dimensional array is the desired upsampled image frame R.

In an embodiment in which (i) sensor 110 is a range sensor having a relatively low spatial resolution and (ii) sensor 120 is a conventional luminance sensor having a relatively high spatial resolution, the upsampled image frame R generated by method 300 is a depth map of the pertinent scene that is analogous to image frame D, but of a higher spatial resolution, e.g., the same spatial resolution as that of image frame X.

In an alternative embodiment, conventional resolution-reduction methods can be used to reduce the spatial resolution of the upsampled image frame R generated at step 310 to any desired value between the spatial resolution of image frame X and the spatial resolution of image frame D.

Note that method 300 relies on an implicit assumption that sparse matrix A generated at step 304 is invertible. However, for some image frames X and D, the determinant of matrix A may be relatively close to zero, which might prevent a computationally stable implementation of step 306. In this situation, an iterative approximate method of finding upsampled image frame R can be used instead of method 300. For example, an article by Diebel, J. R., and Thrun, S., entitled “An Application of Markov Random Fields to Range Sensing,” published in “Advances in Neural Information Processing Systems,” MIT Press, 2006, v. 18, pp. 291-298, describes a suitable conjugate-gradient algorithm that can be used for this purpose. The teachings of this article are incorporated herein by reference in their entirety.

Provided that sparse matrix A generated at step 304 is invertible, method 300 represents a machine-based implementation of a method of finding an exact solution to the mathematical problem of maximizing the conditional probability P(R|X, D) over random field R, with the random-field potentials given by Eqs. (3)-(4). However, in some embodiments, method 300 can also be used for computationally finding an approximate solution to this mathematical problem. More specifically, such an approximate solution can be found, e.g., using the steps of: (i) partitioning each of image frames X and D into sub-frames (tiles) so that, for each sub-frame in image frame D, there is a corresponding sub-frame in image frame X, both covering the same respective field of view; (ii) separately applying method 300 to each matching pair of sub-frames from image frames X and D to generate a corresponding sub-frame (tile) for the full upsampled image frame R; and (iii) appropriately arranging the separately generated sub-frames (tiles) in a two-dimensional array to generate the full approximate upsampled image frame R.

This tile-wise application of method 300 is capable of significantly accelerating the process of generating an upsampled image frame R at the expense of having a somewhat reduced image quality in the resulting upsampled image frame. More specifically, step 306 is the rate-limiting step of method 300 and, therefore, the runtime of the method can be estimated using the runtime of that step alone. As indicated above, for the un-partitioned image frames X and D, step 306 takes approximately M₂N₂³ operations. If each of the frames is partitioned into s² sub-frames (e.g., by dividing each side of the full frame into s equal segments), then the number of operations per sub-frame can be estimated as M₂N/s⁴. The total approximate number of operations for generating the full upsampled image frame R from the s² sub-frames then becomes s²×M₂N₂³/s⁴=M₂N₂³/s². Thus, the tile-wise application of method 300 gives an acceleration factor of about s². However, the upsampled image generated in this manner will have a somewhat reduced quality due to the replacement of an exact global solution of the probability-maximization problem by a combination of tiles, each containing a corresponding local solution of that problem.

In yet another alternative embodiment, a hybrid method can be constructed to combine, in some manner, the application of method 300 and one or more approximate methods (such as the above-mentioned conjugate-gradient algorithm). For example, a conjugate gradient algorithm can be applied to a sub-frame instead of method 300 when the image data in the sub-frame are such that the sparse matrix A corresponding to the sub-frame cannot be reliably computationally inverted, e.g., due to a near-zero determinant value. As another example, when processor 140 has only a limited computational budget that can be allocated to the generation of upsampled image frame R, an ad hoc decision can be made regarding the number of sub-frames and which of the methods (e.g., method 300 or a conjugate-gradient algorithm) to apply to each sub-frame for the superresolution processing not to exceed the available computational budget.

The various parameters of method 300 can be selected and/or adjusted, e.g., using an empirical trial-and-error approach and/or the specified requirements to the quality of the upsampled image. For example, we have found that, for generating upsampled depth maps, the following parameter values provide excellent results: weighting constant q=0.1 (see Eq. (4)); smoothing constant c=5000 (see Eq. (3b)); and number of sub-frames s²=900. A maximum number of iterations for the conjugate-gradient algorithm when it is invoked instead of method 300 can be set to about 200.

In some embodiments, system 100 may not have a sufficiently powerful built-in processor to implement method 300 or have no processor at all. In this situation, a separate image-processing device, such as a computer, can be used to run method 300. For example, after system 100 has acquired image frames X and D, these image frames can be transferred to the memory of a separate image-processing device configured to run method 300. After this image-processing device receives image frames X and D, it can apply to these image frames a suitable embodiment of method 300, thereby generating the requisite upsampled image frame R. If image-frame preprocessing (e.g., step 302) has already been performed (e.g., at system 100) prior to the image-processing device receiving image frames X and D, then the image-processing device can omit step 302.

Some embodiments of method 300 may include the steps of transferring, saving, storing, and/or reading image frames X and D to/in/from a suitable memory coupled to a processor configured to run method 300. Such a memory can be physically located in the same system as the image sensors that have captured the image frames or in a separate system. In the latter case, any suitable (wire-line or wireless) means for transferring electronic files containing the pertinent image frames can be employed.

While this invention has been described with reference to illustrative embodiments, this description is not intended to be construed in a limiting sense. Various modifications of the described embodiments, as well as other embodiments, which are apparent to persons skilled in the art to which the invention pertains are deemed to lie within the scope of the invention as expressed in the following claims.

Embodiments of the invention can be in the form of methods and apparatuses for practicing those methods. Some embodiments can also be in the form of program code, for example, stored in a non-transitory machine-readable storage medium including being loaded into and/or executed by a machine, wherein, when the program code is loaded into and executed by a machine, such as a machine becomes an apparatus for practicing embodiments of the invention. When implemented on a general-purpose processor, the program code segments combine with the processor to provide a unique device that operates analogously to specific logic circuits.

Unless explicitly stated otherwise, each numerical value and range should be interpreted as being approximate as if the word “about” or “approximately” preceded the value of the value or range.

The use of figure numbers and/or figure reference labels in the claims is intended to identify one or more possible embodiments of the claimed subject matter in order to facilitate the interpretation of the claims. Such use is not to be construed as necessarily limiting the scope of those claims to the embodiments shown in the corresponding figures.

Although the elements in the following method claims, if any, are recited in a particular sequence with corresponding labeling, unless the claim recitations otherwise imply a particular sequence for implementing some or all of those elements, those elements are not necessarily intended to be limited to being implemented in that particular sequence.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments necessarily mutually exclusive of other embodiments.

Also for purposes of this description, the terms “couple,” “coupling,” “coupled,” “connect,” “connecting,” or “connected” refer to any manner known in the art or later developed in which energy is allowed to be transferred between two or more elements, and the interposition of one or more additional elements is contemplated, although not required. Conversely, the terms “directly coupled,” “directly connected,” etc., imply the absence of such additional elements.

As used herein in reference to an element and a standard, the term compatible means that the element communicates with other elements in a manner wholly or partially specified by the standard, and would be recognized by other elements as sufficiently capable of communicating with the other elements in the manner specified by the standard. The compatible element does not need to operate internally in a manner specified by the standard.

The embodiments covered by the claims in this application are limited to embodiments that (1) are enabled by this specification and (2) correspond to statutory subject matter. Non-enabled embodiments and embodiments that correspond to non-statutory subject matter are explicitly disclaimed even if they formally fall within the scope of the claims.

The functions of the various elements shown in the figures, including any functional blocks labeled as “processors,” may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, network processor, application specific integrated circuit (ASIC), field programmable gate array (FPGA), read only memory (ROM) for storing software, random access memory (RAM), and non volatile storage. Other hardware, conventional and/or custom, may also be included. Similarly, any switches shown in the figures are conceptual only. Their function may be carried out through the operation of program logic, through dedicated logic, through the interaction of program control and dedicated logic, or even manually, the particular technique being selectable by the implementer as more specifically understood from the context.

It should be appreciated by those of ordinary skill in the art that any block diagrams herein represent conceptual views of illustrative circuitry embodying the invention. Similarly, it will be appreciated that any flow charts, flow diagrams, state transition diagrams, pseudo code, and the like represent various processes which may be substantially represented in computer readable medium and so executed by a computer or processor, whether or not such computer or processor is explicitly shown.

Although embodiments of the invention have been described herein with reference to the accompanying drawings, it is to be understood that embodiments of the invention are not limited to the described embodiments, and one of ordinary skill in the art will be able to contemplate various other embodiments of the invention within the scope of the following claims.

What is claimed is:

1. A machine-implemented method of image processing comprising (A) applying superresolution processing to a first image frame having a first spatial resolution to generate a second image frame having a second spatial resolution that is higher than the first spatial resolution, wherein step (A) comprises:
(A1) generating a sparse matrix based on a Markov random field defined over the first image frame and a third image frame having a third spatial resolution that is higher than the first spatial resolution;
(A2) generating an inverse matrix by inverting the sparse matrix; and
(A3) generating the second image frame using the inverse matrix, wherein:
the first image frame covers a first scene; and
each of the second and third image frames covers the first scene.

2. The method of claim 1, wherein the second spatial resolution is lower than the third spatial resolution.

3. The method of claim 1, wherein:
the third image frame represents a rectangular array of M×N pixels; and
the sparse matrix is a square matrix having MN rows and MN columns, with no more than 5MN non-zero matrix elements.

4. The method of claim 3, wherein the no more than 5MN non-zero matrix elements are located on a set of diagonals consisting of no more than five diagonals of the sparse matrix.

5. The method of claim 4, wherein the set of diagonals includes a main diagonal and two shorter diagonals immediately adjacent to the main diagonal, one on either side thereof.

6. The method of claim 5, wherein the set of diagonals further includes two additional shorter diagonals that are offset from the main diagonal by M or N matrix elements.

7. The method of claim 3, wherein the second image frame represents a rectangular array of M×N pixels.

8. The method of claim 3, wherein:
step (A) further comprises (A4) generating a vector based on the first image frame, said vector having MN elements; and
step (A3) comprises:
generating a string of MN pixel values by calculating a product of the inverse matrix and the vector;
slicing the string of pixel values into M substrings, each having N pixel values; and
generating the second image frame by arranging the M substrings as rows or columns of a two-dimensional array of pixels.

9. The method of claim 1, further comprising:
(B) generating the first image frame using a first image sensor; and
(C) generating the third image using a second image sensor different from the first image sensor.

10. The method of claim 1, further comprising:
(B) partitioning a fourth image frame into a first plurality of sub-frames, wherein the first image frame is a sub-frame of the first plurality; and
(C) partitioning a fifth image frame into a second plurality of sub-frames, wherein the third image frame is a sub-frame of the second plurality.

11. The method of claim 10, wherein:
the fourth image frame covers a second scene, wherein the first scene is a sub-scene of the second scene; and
the fifth image frame covers the second scene.

12. The method of claim 11, further comprising:
(D) applying superresolution processing to another sub-frame of the first plurality to generate a sixth image frame covering another sub-scene of the second scene, said another sub-scene being different from the first scene; and
(E) combining the second image frame and the sixth image frame to generate a combined image frame corresponding to the second scene.

13. The method of claim 12, wherein step (E) comprises arranging the second image frame and the sixth image frame as tiles of the combined image frame.

14. The method of claim 12, wherein step (D) comprises:
(D1) generating a second sparse matrix based on a Markov random field defined over said another sub-frame of the first plurality and a sub-frame of the second plurality corresponding to said another sub-frame of the first plurality;
(D2) generating a second inverse matrix by inverting the second sparse matrix; and
(D3) generating the sixth image frame using the second inverse matrix.

15. The method of claim 12, wherein step (D) comprises applying a conjugate-gradient algorithm to said another sub-frame of the first plurality to generate the sixth image frame.

16. The method of claim 1, wherein:
the first image frame is a depth map of the first scene captured by a range sensor;
the second image frame is an upsampled depth map of the first scene; and
the third image frame is a photograph of the first scene captured by a luminosity sensor.

17. The method of claim 1, further comprising (B) performing at least one of image registration and image trimming to generate the first image frame and the third image frame.

18. A non-transitory machine-readable medium, having encoded thereon program code, wherein, when the program code is executed by a machine, the machine implements a method of image processing, the method comprising:
(A) applying superresolution processing to a first image frame having a first spatial resolution to generate a second image frame having a second spatial resolution that is higher than the first spatial resolution, wherein step (A) comprises:
(A1) generating a sparse matrix based on a Markov random field defined over the first image frame and a third image frame having a third spatial resolution that is higher than the first spatial resolution;
(A2) generating an inverse matrix by inverting the sparse matrix; and
(A3) generating the second image frame using the inverse matrix, wherein:
the first image frame covers a first scene; and
each of the second and third image frames covers the first scene.

19. An apparatus comprising:
a memory configured to store (i) a first image frame covering a first scene, said first image frame having a first spatial resolution, and (ii) a second image frame covering the first scene, said second image frame having a second spatial resolution that is higher than the first spatial resolution; and
a processor configured to apply superresolution processing to the first image frame to generate a third image frame covering the first scene, said third image frame having a third spatial resolution that is higher than the first spatial resolution, wherein the processor is further configured to:
generate a sparse matrix based on a Markov random field defined over the first image frame and the second image frame;
generate an inverse matrix by inverting the sparse matrix; and
generate the third image frame using the inverse matrix.

20. The apparatus of claim 19, further comprising:
a range sensor configured to generate image data for the first image frame; and
a luminosity sensor configured to generate image data for the second image frame.
